(19) United States
(12) Patent Application Publication
(10) Pub. No.: US 2026/0252708 A1
(43) Pub. Date: Aug. 27, 2026

(54) METHOD, APPARATUS, DEVICE AND MEDIUM FOR MANAGING CODE OF APPLICATION

(71) Applicant: Beijing Zitiao Network Technology Co., Ltd., Beijing (CN)

(72) Inventors: Jianhua ZHU, Beijing (CN); Hengjie ZHENG, Beijing (CN); Cheng GUO, Beijing (CN)

(21) Appl. No.: 19/187,942

(22) Filed: Apr. 23, 2025

Related U.S. Application Data
(63) Continuation of application No. PCT/CN2025/078679, filed on Feb. 23, 2025.

(51) Int. Cl. G06F 21/57

(52) U.S. Cl. CPC G06F 21/577; G06F 2221/033

(57) ABSTRACT

A method, an apparatus, a device, and a medium for managing code for an application are provided. In a method, a calling relationship for at least one code element in the code of the application is determined. A data flow processed by the code of the application is obtained, the data flow including at least one data item processed by the at least one code element. A risk path associated with the code of the application is determined, the risk path indicating a call path of a code element in the application that causes a potential risk. Based on the calling relationship, the data flow and the risk path, the potential risk in the code of the application is determined.

### CROSS REFERENCE

This application claims priority to PCT Application No. PCT/CN2025/078679, filed on Feb. 23, 2025 and entitled “METHOD, APPARATUS, DEVICE AND MEDIUM FOR MANAGING CODE OF APPLICATION”, the entirety of which is incorporated herein by reference.

### FIELD

Implementations of the disclosure generally relate to computer technologies, and in particular, to a method, an apparatus, a device, and a computer-readable storage medium for managing code of an application.

### BACKGROUND

With the development of computer technologies, multiple programming languages may be used to write code of an application, and applications with different functions are implemented. During the process of writing code by a developer, various risks may be introduced. To ensure that the application can achieve an intended function, the code of the application needs to be checked to find potential risks in the code. However, for different applications, developers with rich experience are required to perform a risk check process in order to determine and exclude risks in the code of respective applications. This may lead to a large amount of manpower and time overhead. At this point, it is desirable to manage the code of the application in a more general and efficient manner and determine the risk in the code.

### SUMMARY

In a first aspect of the disclosure, a method for managing code of an application is provided. In the method, a calling relationship of at least one code element in the code of the application is determined. A data flow processed by the code of the application is obtained, the data flow including at least one data item processed by the at least one code element. A risk path associated with the code of the application is determined, the risk path indicating a call path of a code element in the application that causes a potential risk. Based on the calling relationship, the data flow and the risk path, the potential risk in the code of the application is determined.

In a second aspect of the disclosure, an apparatus for managing code of an application is provided. The apparatus includes: a relationship determining module configured to determine a calling relationship of at least one code element in the code of the application; an obtaining module configured to obtain a data flow processed by the code of the application, the data flow including at least one data item processed by the at least one code element; a path determining module configured to determine a risk path associated with the code of the application, the risk path indicating a call path of a code element in the application that causes a potential risk; and a risk determining module configured to determine the potential risk in the code of the application based on the calling relationship, the data flow, and the risk path.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a computer-readable storage medium having stored thereon a computer program which, when executed by a processor, causes the processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the content described in this disclosure is not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, in which:

FIG. 1 shows a block diagram of an application environment according to an implementation of the disclosure;

FIG. 2 shows a block diagram for managing code of an application according to some implementations of the disclosure;

FIG. 3 shows a block diagram for determining a calling relationship between code elements in a code according to some implementations of the disclosure;

FIG. 4 shows a block diagram of establishing a mapping between a code feature and a risk by utilizing a rule according to some implementations of the disclosure;

FIG. 5 shows a block diagram for determining a risk in code according to some implementations of the disclosure;

FIG. 6 shows a flowchart of a method for managing code of an application according to some implementations of the disclosure;

FIG. 7 shows a block diagram of an apparatus for managing code of an application according to some implementations of the disclosure; and

FIG. 8 shows a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate mode according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, in a manner of a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process for obtaining a user authorization is merely illustrative, and does not constitute a limitation on implementations of the disclosure, and other manners of meeting related laws and regulations may also be applied to implementations of the disclosure.

The term “in response to” as used herein means a state in which a respective event occurs or a condition is satisfied. It will be appreciated that the timing of execution of a subsequent action performed in response to the event or condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

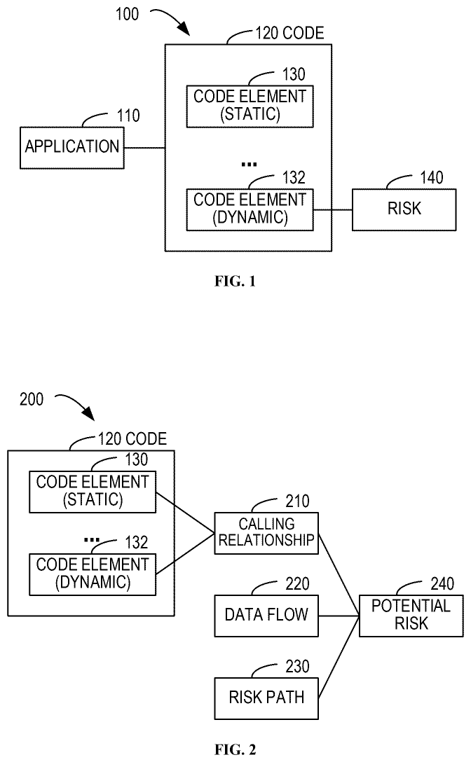

With the development of computer technologies, multiple programming languages may be used to write code of an application, and applications with different functions are implemented. During the process of writing code by a developer, various risks may be introduced. An application environment according to some implementations of the disclosure is described with reference to FIG. 1, and FIG. 1 is a block diagram 100 of an application environment according to an implementation of the disclosure. As shown in FIG. 1, code 120 of an application 110 may be written in a variety of programming languages. The code 120 may include a plurality of code elements, and the code elements may include one or more static code elements 130, and/or one or more dynamic code elements 132.

In the development process, to ensure neat and less modification of code, different service functions in an application may use the same code. Some service functions may be abstracted into configurations in a dynamic manner, transmitting from outside to the configuration during execution of the application to enable reuse of code. However, the dynamic manner may lead to: in the same data processing channel, various variable data may be theoretically transmitted, and a plurality of variable logical functions may be performed, which results in a great data security risk. For example, in a data processing process, a source of data, a processor of data, and a transmission destination of data may not conform to a data security requirement, which leads to a data security risk. For example, calling of the code element 132 may a risk 140.

To ensure that the application can achieve an intended function, the code of the application needs to be checked to find potential risks in the code. However, for different applications, developers with rich experience are required to perform a risk check process in order to determine and exclude risks in the code of respective applications. This may lead to a large amount of manpower and time overhead. At this point, it is desirable to manage the code of the application in a more general and efficient manner and determine the risk in the code.

### Summary of Code Management

In order to at least partially solve the deficiencies in the prior art, according to an implementation of the disclosure, a method for managing code of an application is provided. A summary according to an implementation of the disclosure is described with reference to FIG. 2, and FIG. 2 shows a schematic diagram for managing code of an application according to some implementations of the disclosure. As shown in FIG. 2, a method for managing code of an application is provided. Specifically, a calling relationship 210 of at least one code element 130, . . . , and 132 in the code 120 of the application may be determined. Here, the code element may represent various programming elements in the code. The code elements may be determined at different granularities, for example, the code elements may include, but are not limited to, functions, processes, code segments, statements, and the like.

A data flow 220 processed by the code of the application may be obtained. The data flow 220 may include at least one data item processed by the at least one code element. Here, the data flow refers to a data item transferred between functional units defined by respective code elements in an application during running of the application. For example, in a media application, the data item may include a data item related to an object (e.g., a user, etc.) in the media application, a data item related to a video, and other data items for supporting data transmission in the media application, and like. A risk path associated with the code of the application may be determined, the risk path 230 indicating a call path of a code element in the application that causes a potential risk 240. In turn, the potential risk 240 in the code 120 of the application may be determined based on the calling relationship 210, the data flow 220, and the risk path 230.

With some implementations of the disclosure, the code of the application may be automatically analyzed and the calling relationship of the corresponding code element and the data flow processed by the application may be obtained. Further, the risk path may be utilized to specify an association between the code and the potential risk, thereby determining the potential risk in the code. In this way, it is not necessary to perform a dedicated risk analysis process for each application, and the potential risk in code for different applications may be determined in a more general manner.

### Detailed Process of Code Management

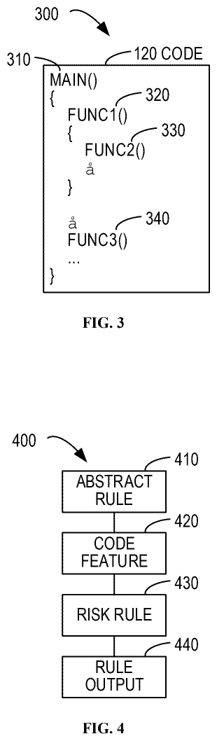

Having described a summary according to some implementations of the disclosure, more details regarding a method for managing code for an application will be described below. According to some implementations of the disclosure, the calling relationship of at least one code element in the code of the application may be determined. More details are described with reference to FIG. 3, which shows a block diagram 300 for determining a calling relationship between respective code elements in the code according to some implementations of the disclosure. As shown in FIG. 3, the code 120 may include a plurality of code elements. A function is taken as an example of the code element only, the code 120 may include a function 310, a function 320, a function 330, . . . , and a function 340. The function 310 may call the function 320, . . . , and 340, and the function 320 may further call the function 330.

It should be understood that the code 120 in FIG. 3 is merely illustrative. The code 120 may include a single file, alternatively and/or additionally, the code 120 may include a plurality of files located at different locations, and at this time, the code 120 may be stored in a distributed manner. In a case that the code 120 includes a plurality of files, the calling relationship may further indicate a location of a file in which a respective code element is located.

According to some implementations of the disclosure, the data flow 220 processed by the code of the application may be obtained, the data flow 220 including at least one data item processed by the at least one code element. It should be understood that since the code of the application may include a dynamic statement, and only during running of the application, the actual content of the dynamic statement may be determined. The data flow herein includes data items that are actually processed by various code elements in the application during running of the application. Specifically, in the process of obtaining the data flow, the code of the application may be compiled to generate an intermediate representation (abbreviated as IR).

Here, the intermediate representation refers to an intermediate representation obtained from source code in a compiler or interpreter. This intermediate representation is a format between the source code and final machine code, and the intermediate representation is closer to the machine code but in the form of platform-independent representation. The intermediate representation allows the compiler to optimize and transfer at different stages without the need to re-design these stages for each source language or target platform. Further, the intermediate representation may be run to determine data items processed by respective code elements. Input data having a marker may be provided to the running application. During running of the application, the input data having the marker may be tracked to obtain the data flow.

Specifically, the data flow may be determined using a taint data analysis. Taint data generally refers to external input data accepted by the application, and the data may be stored in a form of temporary data or in a form of a file. When an application needs to use these data, data access and processing are generally performed through functions or system calls. In the taint data analysis, input data from outside is marked as taint data. The taint data analysis may be performed when the application is running, and flowing of the taint data in the application may be tracked. By tracking the flowing of the taint data, a propagation path of data in the application may be found, thereby identifying potential security risks. According to some implementations of the disclosure, it may be detected in real time whether a security risk exists in the data processed by the dynamic statement by obtaining the data flow processed by the application during running in real time.

According to some implementations of the disclosure, the risk path associated with the code of the application may be determined, and the risk path may indicate a call path of a code element in the application that causes a potential risk. Specifically, it may be determined whether the code includes a predetermined risk feature, and the risk feature may represent a feature in the code that may cause a potential risk. For example, the risk feature may include a dynamic statement, and the dynamic statement includes a dynamic query statement or a dynamic script. Here, the dynamic query statement may include, for example, a dynamic structured query language (SQL), and the dynamic script may include a script in any format supported by the programming language of the code.

It should be understood that, the specific content of the dynamic statement may be determined only when the application is run, and then it is determined whether there is a risk, so that the potential risk in the code cannot be detected in a static manner. With some implementations of the disclosure, the potential risk in the code may be detected in a more accurate manner by running the application and detecting the dynamic query statement and/or the dynamic script.

According to some implementations of the disclosure, in response to determining that the code includes a predetermined risk feature, based on the risk feature and a type of a programming language used by the code, a risk element in the code corresponding to the risk feature is determined, the risk element may cause the potential risk in the application. Then, the risk path may be determined based on the call path of the risk element in the code. It should be understood that the code may be written using different types of programming languages, the type of the programming language used by the code may be firstly determined, and it is further determined whether the code includes a risk element corresponding to the risk feature. For example, for a Go language, a dynamic statement Exec( ) may be utilized to dynamically invoke an external statement. At this time, Exec( ) may cause a potential risk in the application, and thus, Exec( ) is a risk element. Further, Exec( ) may be searched in the code to determine the call path of Exec( ).

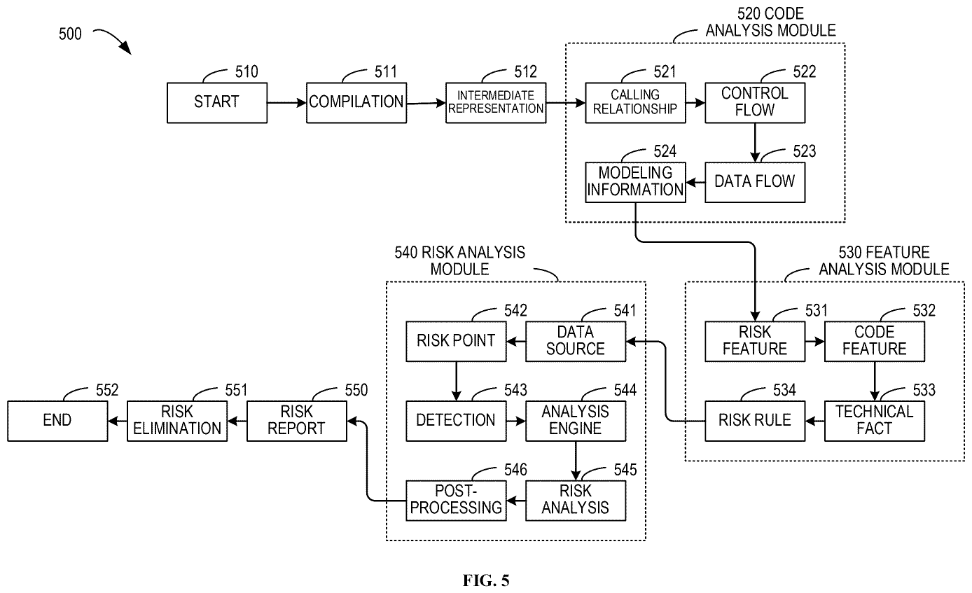

Further details are described with reference to FIG. 4, which shows a block diagram 400 of establishing a mapping between a code feature and a risk feature by utilizing a rule according to some implementations of the disclosure. As shown in FIG. 4, a risk feature possibly causing a risk may be used as an input to determine a corresponding rule output. Specifically, at block 410, the risk feature (e.g., a risk of execution of dynamic SQL) may be input to determine an abstract rule. Specifically, the dynamic SQL may be received, and the dynamic SQL may perform different tasks and lead to difficulties in detecting and controlling these tasks. For example, the dynamic SQL may access different fields in different databases and lead to a risk of illegal access to certain fields. At this time, the abstract rule may specify that such a dynamic SQL needs to be monitored.

At block 420, the code feature corresponding to the risk feature may be determined, i.e., specific code elements conforming to the dynamic SQL are identified from the code. Specifically, different programming languages may have different dynamic execution capabilities, and at this time, a specific statement with dynamic execution capability needs to be determined according to a specific type and an abstract rule of the programming language. For example, in the Go language, a mapping relationship may be established between the dynamic SQL and the Exec( ).

At block 430, a risk rule for detecting a risk may be determined, and the risk rule is also referred to as a risk path and may indicate a call path of a code element in the application that causes a potential risk. According to some implementations of the disclosure, in the process of determining the risk path based on the call path of the risk element in the code, a start point of the risk path may be determined based on a start point of the call path. Here, the start point of the call path represents an initial entry for calling the risk element, for example, a Remote Procedure Call (abbreviated as RPC) entry, or a HyperText Transfer Protocol (HTTP) entry. Further, an end point of the risk path may be determined based on the risk element. Specifically, the end point of the risk path may be denoted as Exec( ).

At block 440, a final rule may be output, and the rule may include: a start point, a propagation parameter of the risk path, and an end point. Specifically, the propagation parameter of the risk path may be determined based on the parameter of the code element in the call path. Continuing with the example as mentioned above, it may be determined whether the parameter of the code element in the call path matches a predetermined concern parameter. Here, the concern parameter may be a pre-specified parameter that may cause a data security risk, that is, a parameter expected to be protected. For example, the concern parameter may be parsed from a programming specification, or the concern parameter may be specified from a code security specification, or the concern parameter may be specified manually.

In the process of determining the propagation parameter of the risk path, in response to determining that the parameter of the code element in the call path matches the predetermined concern parameter, the propagation parameter of the risk path may be determined based on the concern parameter. Specifically, it is assumed that the parameter for determining the code element in the call path includes Parameter1, and the Parameter1 is the concern parameter. At this time, it may be determined that the Parameter1 is the propagation parameter of the risk path. In this case, the output rule may be expressed as: RPC/HTTP, Parameter1, Exec( ), and the rule may represent a risk path for detecting a risk in the code.

It should be understood that only one concern parameter is schematically illustrated herein, alternatively and/or additionally, there may be one or more concern parameters, e.g., Parameter2, Parameter3, etc. Further, although the process of determining the risk element is described above only by using the Go language as an example of the programming language, the code written in other languages may be processed in a similar manner, thereby determining the corresponding risk path.

According to some implementations of the disclosure, the potential risk in the code of the application may be determined based on the calling relationship, the data flow, and the risk path. Specifically, an entry location in the code that causes the potential risk may be determined based on the calling relationship and the start point of the risk path. Continuing the example above, it may be determined that the entry location in the code that causes the potential risk is RPC/HTTP. Further, a risk data portion of the data flow that is located after the entry location may be determined, that is, the RPC/HTTP parameter at a code point of the entry location may be determined. In turn, the potential risk may be determined based on the risk data portion and the propagation parameter. Specifically, assuming that there is a concern parameter Parameter1 in the RPC/HTTP parameter, it may be determined that there is a risk; otherwise, it may be determined that there is no risk.

According to some implementations of the disclosure, a risk report may be provided. For example, the risk report may include at least any of the following: a description of the risk, a start point of the risk, and an end point of the risk, and the like. For example, Table 1 shows an example of the risk report. Further, the code of the application may be optimized based on the detected potential risk to reduce the risk of data leakage.

TABLE 1
Example of Risk Report

| | |
|---|---|
| Description of Risk | Code in a path/aaa/bbb/ccc of a XX application performs dynamic access to a database |
| | DB1, and a risk of leaking data in the database DB1 may exist. |
| Start Point of Risk | A code execution method in the path/aaa/bbb/ccc of the XX application |
| | method: post. |
| End Point of Risk | The code of the XX application executes a db.Exec( ) method. |

Having described various steps in some implementations according to the disclosure, hereinafter, a complete process for managing code is described with reference to FIG. 5. FIG. 5 shows a block diagram 500 for determining a risk in the code according to some implementations of the disclosure. As shown in FIG. 5, the method described above may be performed with a code analysis module 520, a feature analysis module 530, and a risk analysis module 540. The method may begin at block 510. At block 511, source code of the application may be compiled, and an intermediate representation may be generated at block 512.

Further, the code analysis module 520 may parse respective code elements in the code and determine a calling relationship 521 between the respective code elements. It should be understood that although FIG. 5 shows determining the calling relationship from the intermediate representation 512, alternatively and/or additionally the calling relationship may be determined from the source code. A control flow 522 (for controlling a call order of respective code elements in the code) may be determined based on the calling relationship 521. Further, a data flow 523 processed by the respective code element in the application may be determined, and then the corresponding modeling information 524 is determined. Here, the modeling information 524 represents a data item in the data flow, and a specific service meaning of respective data items is not known at this time.

At a subsequent stage, the feature analysis module 530 may establish a mapping between the data item and the service data expected to be detected, i.e., determine a data item that is expected to be protected, which may involve a security risk. Specifically, a risk feature 531 (e.g., a dynamic SQL) may be determined and a corresponding code feature 532 (e.g., Exec( ) in the Go language) may be determined. Further, a technical fact 533 during execution of the application may be determined, thereby generating a corresponding risk rule 534 (e.g., RPC/HTTP, Parameter1, Exec( ).

Then, the risk analysis module 540 may generate a risk report 550 based on the output of the feature analysis module 530. Specifically, the risk analysis module 540 may receive the risk rule 534, and the control flow 522, the data flow 523, as a data source 541 to be analyzed. A risk point 542 (e.g., Exec( )) expected to be analyzed may be determined, an analysis engine 544 is built based on the data detected at block 543, and then a risk analysis 545 is performed. Post-processing 546 may be performed, for example, content and format of the risk report, etc. may be specified, and the risk report 550 may be generated. In response to determining that there is a risk in the code, the code may be optimized and the risk may be eliminated at block 551. The method ends at block 552.

According to some implementations of the disclosure, different applications may be processed in a common manner. Specifically, the related control flow and data flow of each application may be determined by the code analysis module 520, and then subsequent risk detection is performed. With some implementations of the disclosure, the code of the application may be automatically analyzed and the calling relationship of the corresponding code element and the data flow processed by the application may be obtained. Further, the risk path may be utilized to specify an association between the code and the potential risk, thereby determining the potential risk in the code. In this way, it is not necessary to perform a dedicated risk analysis process for each application, and the potential risk in the code for different applications may be determined in a more general manner.

### Example Processes

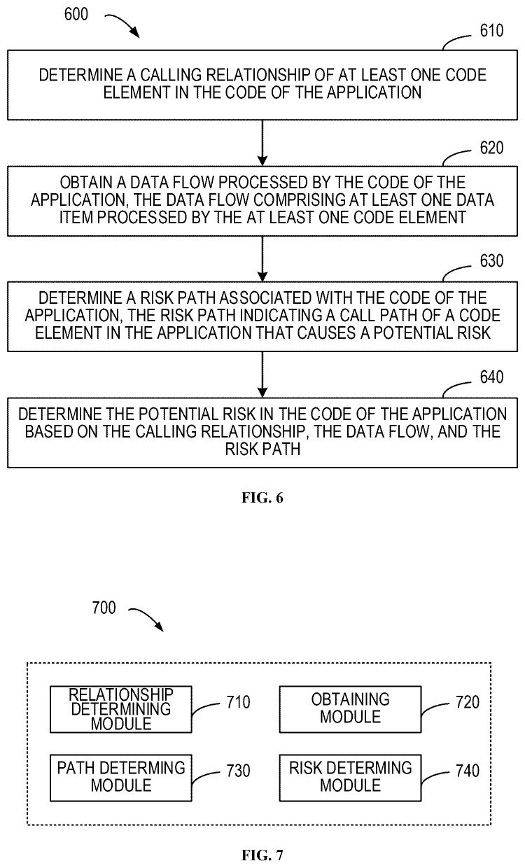

FIG. 6 shows a flowchart of a method 600 for managing code of an application according to some implementations of the disclosure. At block 610, a calling relationship of at least one code element in the code of the application is determined. At block 620, a data flow processed by the code of the application is obtained, the data flow including at least one data item processed by the at least one code element. At block 630, a risk path associated with the code of the application is determined, the risk path indicating a call path of a code element in the application that causes a potential risk. At block 640, the potential risk in the code of the application is determined based on the calling relationship, the data flow, and the risk path.

According to some implementations of the disclosure, determining the risk path associated with the code of the application includes: determining, in response to determining that the code includes a predetermined risk feature, a risk element in the code corresponding to the risk feature based on the risk feature and a type of a programming language used by the code, the risk element causing the potential risk in the application; and determining the risk path based on a call path of the risk element in the code.

According to some implementations of the disclosure, the risk feature includes a dynamic statement, and the dynamic statement includes a dynamic query statement or a dynamic script.

According to some implementations of the disclosure, determining the risk path based on the call path of the risk element in the code includes: determining a start point of the risk path based on a start point of the call path; determining a propagation parameter of the risk path based on a parameter of a code element in the call path; and determining an end point of the risk path based on the risk element.

According to some implementations of the disclosure, determining the propagation parameter of the risk path includes: determining the propagation parameter of the risk path based on a predetermined concern parameter in response to determining that the parameter of the code element in the call path matches the concern parameter.

According to some implementations of the disclosure, determining the potential risk in the code of the application based on the calling relationship, the data flow, and the risk path includes: determining an entry location in the code that causes the potential risk based on the calling relationship and the start point of the risk path; determining a risk data portion of the data flow that is located after the entry location; and determining the potential risk based on the risk data portion and the propagation parameter.

According to some implementations of the disclosure, obtaining the data flow includes: providing to the application input data having a marker; and tracking the input data having the marker to obtain the data flow during running of the application.

### Example Apparatus and Device

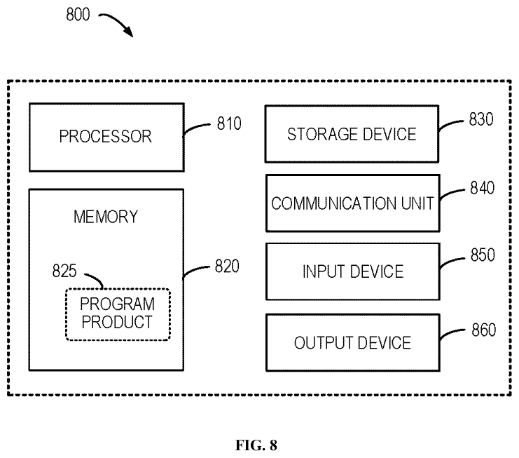

FIG. 7 shows a block diagram of an apparatus 700 for managing code of an application according to some implementations of the disclosure. The apparatus 700 includes: a relationship determining module 710 configured to determine a calling relationship of at least one code element in the code of the application; an obtaining module 720 configured to obtain a data flow processed by the code of the application, the data flow including at least one data item processed by the at least one code element; a path determining module 730 configured to determine a risk path associated with the code of the application, the risk path indicating a call path of a code element in the application that causes a potential risk; and a risk determining module 740 configured to determine the potential risk in the code of the application based on the calling relationship, the data flow, and the risk path.

According to some implementations of the disclosure, the path determining module 730 is further configured to: determine, in response to determining that the code includes a predetermined risk feature, a risk element in the code corresponding to the risk feature based on the risk feature and a type of a programming language used by the code, the risk element causing the potential risk in the application; and determine the risk path based on a call path of the risk element in the code.

According to some implementations of the disclosure, the risk feature includes a dynamic statement, and the dynamic statement includes a dynamic query statement or a dynamic script.

According to some implementations of the disclosure, the path determining module 730 is further configured to: determine a start point of the risk path based on a start point of the call path; determine a propagation parameter of the risk path based on a parameter of a code element in the call path; and determine an end point of the risk path based on the risk element.

According to some implementations of the disclosure, the path determining module 730 is further configured to: determine the propagation parameter of the risk path based on a predetermined concern parameter in response to determining that the parameter of the code element in the call path matches the concern parameter.

According to some implementations of the disclosure, the risk determining module 740 is further configured to: determine an entry location in the code that causes the potential risk based on the calling relationship and the start point of the risk path; determine a risk data portion of the data flow that is located after the entry location; and determine the potential risk based on the risk data portion and the propagation parameter.

According to some implementations of the disclosure, the obtaining module 720 is further configured to: provide to the application input data having a marker; and track the input data having the marker to obtain the data flow during running of the application.

FIG. 8 shows a block diagram of a device 800 capable of implementing various implementations of the disclosure. It should be understood that a computing device 800 shown in FIG. 8 is merely illustrative and should not constitute any limitation on the functionality and scope of the implementations described herein. The computing device 800 shown in FIG. 8 may be configured to implement the method described above.

As shown in FIG. 8, the computing device 800 is in a form of a general-purpose computing device. Components of the computing device 800 may include, but are not limited to, one or more processors 810, a memory 820, a storage device 830, one or more communication units 840, one or more input devices 850, and one or more output devices 860. The processor 810 may be an actual or virtual processor and capable of performing various processes according to programs stored in the memory 820. In a multiprocessor system, the processors execute computer-executable instructions in parallel to improve the parallel processing capability of the computing device 800.

The computing device 800 generally includes a plurality of computer storage media. Such media may be any available media accessible by the computing device 800, including, but not limited to, volatile and non-volatile media, removable and non-removable media. The memory 820 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 830 may be a removable or non-removable medium and may include a machine-readable medium, such as a flash drive, a magnetic disk, or any other medium, which may be capable of storing information and/or data (e.g., training data for training) and may be accessed within the computing device 800.

The computing device 800 may further include additional removable/non-removable, volatile/non-volatile storage media/medium. Although not shown in FIG. 8, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 820 may include a computer program product 825 having one or more program modules configured to perform various methods or actions of various implementations of the disclosure.

The communication unit 840 implements communications with other computing devices through a communication medium. Additionally, the functionality of components of the computing device 800 may be implemented in a single computing cluster or multiple computing machines capable of communicating through a communication connection. Thus, the computing device 800 may operate in a networked environment using logical connection(s) with one or more other servers, a network personal computer (PC), or another network node.

The input device 850 may be one or more input devices, such as a mouse, a keyboard, a trackball, or the like. The output device 860 may be one or more output devices, such as a display, a speaker, a printer, or the like. The computing device 800 may also communicate with one or more external devices (not shown) as needed, the external device such as a storage device, a display device, etc., communicates with one or more devices that enable a user to interact with the computing device 800, or communicates with any device (e.g., a network card, a modem, etc.) that enables the computing device 800 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, and the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processor of a general purpose computer, special purpose computer, or other programmable data processing apparatus to produce a machine, such that the instructions, when executed by a processor of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for managing code of an application, comprising:
determining a calling relationship of at least one code element in the code of the application;
obtaining a data flow processed by the code of the application, the data flow comprising at least one data item processed by the at least one code element;
determining a risk path associated with the code of the application, the risk path indicating a call path of a code element in the application that causes a potential risk; and
determining the potential risk in the code of the application based on the calling relationship, the data flow, and the risk path.

2. The method of claim 1, wherein determining the risk path associated with the code of the application comprises:
determining, in response to determining that the code comprises a predetermined risk feature, a risk element in the code corresponding to the risk feature based on the risk feature and a type of a programming language used by the code, the risk element causing the potential risk in the application; and
determining the risk path based on a call path of the risk element in the code.

3. The method of claim 2, wherein the risk feature comprises a dynamic statement, and the dynamic statement comprises a dynamic query statement or a dynamic script.

4. The method of claim 2, wherein determining the risk path based on the call path of the risk element in the code comprises:
determining a start point of the risk path based on a start point of the call path;
determining a propagation parameter of the risk path based on a parameter of a code element in the call path; and
determining an end point of the risk path based on the risk element.

5. The method of claim 4, wherein determining the propagation parameter of the risk path comprises: determining the propagation parameter of the risk path based on a predetermined concern parameter in response to determining that the parameter of the code element in the call path matches the concern parameter.

6. The method of claim 4, wherein determining the potential risk in the code of the application based on the calling relationship, the data flow, and the risk path comprises:
determining an entry location in the code that causes the potential risk based on the calling relationship and the start point of the risk path;
determining a risk data portion of the data flow that is located after the entry location; and
determining the potential risk based on the risk data portion and the propagation parameter.

7. The method of claim 1, wherein obtaining the data flow comprises:
providing to the application input data having a marker; and
tracking the input data having the marker to obtain the data flow during running of the application.

8. An electronic device, comprising:
at least one processor; and
at least one memory coupled to the at least one processor and storing instructions for execution by the at least one processor, the instructions, when executed by the at least one processor, causing the electronic device to perform acts comprising:
determining a calling relationship of at least one code element in code of an application;
obtaining a data flow processed by the code of the application, the data flow comprising at least one data item processed by the at least one code element;
determining a risk path associated with the code of the application, the risk path indicating a call path of a code element in the application that causes a potential risk; and
determining the potential risk in the code of the application based on the calling relationship, the data flow, and the risk path.

9. The electronic device of claim 8, wherein determining the risk path associated with the code of the application comprises:
determining, in response to determining that the code comprises a predetermined risk feature, a risk element in the code corresponding to the risk feature based on the risk feature and a type of a programming language used by the code, the risk element causing the potential risk in the application; and
determining the risk path based on a call path of the risk element in the code.

10. The electronic device of claim 9, wherein the risk feature comprises a dynamic statement, and the dynamic statement comprises a dynamic query statement or a dynamic script.

11. The electronic device of claim 9, wherein determining the risk path based on the call path of the risk element in the code comprises:
determining a start point of the risk path based on a start point of the call path;
determining a propagation parameter of the risk path based on a parameter of a code element in the call path; and
determining an end point of the risk path based on the risk element.

12. The electronic device of claim 11, wherein determining the propagation parameter of the risk path comprises: determining the propagation parameter of the risk path based on a predetermined concern parameter in response to determining that the parameter of the code element in the call path matches the concern parameter.

13. The electronic device of claim 11, wherein determining the potential risk in the code of the application based on the calling relationship, the data flow, and the risk path comprises:
determining an entry location in the code that causes the potential risk based on the calling relationship and the start point of the risk path;
determining a risk data portion of the data flow that is located after the entry location; and
determining the potential risk based on the risk data portion and the propagation parameter.

14. The electronic device of claim 8, wherein obtaining the data flow comprises:
providing to the application input data having a marker; and
tracking the input data having the marker to obtain the data flow during running of the application.

15. A non-transitory computer-readable storage medium having stored thereon computer instructions that, when executed by a processor, cause the processor to perform acts comprising:
determining a calling relationship of at least one code element in code of an application;
obtaining a data flow processed by the code of the application, the data flow comprising at least one data item processed by the at least one code element;
determining a risk path associated with the code of the application, the risk path indicating a call path of a code element in the application that causes a potential risk; and
determining the potential risk in the code of the application based on the calling relationship, the data flow, and the risk path.

16. The non-transitory computer-readable storage medium of claim 15, wherein determining the risk path associated with the code of the application comprises:
determining, in response to determining that the code comprises a predetermined risk feature, a risk element in the code corresponding to the risk feature based on the risk feature and a type of a programming language used by the code, the risk element causing the potential risk in the application; and
determining the risk path based on a call path of the risk element in the code.

17. The non-transitory computer-readable storage medium of claim 16, wherein the risk feature comprises a dynamic statement, and the dynamic statement comprises a dynamic query statement or a dynamic script.

18. The non-transitory computer-readable storage medium of claim 16, wherein determining the risk path based on the call path of the risk element in the code comprises:
determining a start point of the risk path based on a start point of the call path;
determining a propagation parameter of the risk path based on a parameter of a code element in the call path; and
determining an end point of the risk path based on the risk element.

19. The non-transitory computer-readable storage medium of claim 18, wherein determining the propagation parameter of the risk path comprises: determining the propagation parameter of the risk path based on a predetermined concern parameter in response to determining that the parameter of the code element in the call path matches the concern parameter.

20. The non-transitory computer-readable storage medium of claim 18, wherein determining the potential risk in the code of the application based on the calling relationship, the data flow, and the risk path comprises:
determining an entry location in the code that causes the potential risk based on the calling relationship and the start point of the risk path;
determining a risk data portion of the data flow that is located after the entry location; and
determining the potential risk based on the risk data portion and the propagation parameter.
